(19) United States
(12) Patent Application Publication
(10) Pub. No.: US 2015/0192738 A1
(43) Pub. Date: Jul. 9, 2015

(54) OPTICAL FIBER PROCESSING SYSTEM USING A CO2 LASER

(71) Applicant: AFL TELECOMMUNICATIONS LLC, Duncan, SC (US)

(72) Inventors: Wenxin Zheng, Moore, SC (US); Toshirou Mizushima, Greer, SC (US); Hiroshi Sugawara, Greenville, SC (US); William Klimowych, Greenville, SC (US); Doug Duke, Simpsonville, SC (US)

(73) Assignee: AFL TELECOMMUNICATIONS LLC, Duncan, SC (US)

(21) Appl. No.: 14/411,245

(22) PCT Filed: Jun. 27, 2013
(86) PCT No.: PCT/US13/48228

§ 371 Date: Dec. 24, 2014

Related U.S. Application Data
(60) Provisional application No. 61/664,983, filed on Jun. 27, 2012.
(60) Provisional application No. 61/664,969, filed on Jun. 27, 2012.

(51) Int. Cl. G02B 6/255

(52) U.S. Cl. CPC G02B 6/2551; G02B 6/2553

(57) ABSTRACT

An apparatus for splicing, tapering and heat processing optical fibers is disclosed. The apparatus may include a laser configured to irradiate a portion of one or more optical fibers by at least two laser beams. The beams may be configured to irradiate different areas of the exterior surface of the fiber portion such as to increase the uniformity of heating distribution over the exterior surface of a portion of the optical fiber. In a configuration using two beams to irradiate the fiber portion the angle between the beams may be the closest angle to 180 degrees for which coupling between the first beam and the second beam is avoided. The apparatus may include three or more beams distributed around the optical fiber such as to irradiate the fiber portion uniformly and provide uniform heating of the fiber.

### CROSS-REFERENCE TO RELATED APPLICATIONS

This application is based upon and claims the benefit of priority from U.S. Provisional Applications No. 61/664,969, filed Jun. 27, 2012, and Provisional Application No. 61/664,983, filed Jun. 27, 2012 in the United States Patent and Trademark Office, the disclosures of which are incorporated herein in its entirety by reference.

### BACKGROUND

1. Field

The invention relates to an apparatus, system and method for splicing, tapering, and processing optical fibers.

2. Related Art and Background

Splicing and tapering optical fibers are necessary and often performed procedures in the development and maintenance of optical fiber networks, systems and devices.

Splicing of two optical fibers refers to joining the two fibers together end to end. Splicing may be performed mechanically or by fusion. Fusion splicing refers to fusing or welding, by using a heat source, two fibers together. Fusion splicing is the most widely used method of splicing because it provides low loss, low reflectance, and strong and reliable joint between two fibers. FIG. 1 shows a schematic diagram of splicing two fibers 1a and 1b.

Tapering of an optical fiber refers to a process of reducing the diameter of a fiber over a certain region or length. Tapering may be performed by heating the fiber and applying a tensile force to stretch and thin the fiber. Such a method may taper the core and cladding evenly and at the same time which results in a taper that changes only the fiber diameter. FIG. 2 shows a schematic diagram of tapering a fiber.

Several types of fusion splicing have been developed, such as: heating the ends of the fibers to be joined with a flame torch, heating the fibers by an electrode arc discharge, heating the fibers by a filament heater, and heating the fibers by a CO₂ laser. The above methods may also be used to perform tapering. Among these methods, the one using a CO₂ laser has the advantage of being the cleanest and not causing deposits on the fibers.

The CO₂ laser can be used as heat source to heat fibers, ensuring repeatable performance and low maintenance and eliminating electrode or filament maintenance and instability. CO₂ laser heating also eliminates any deposits on the fiber surface that might occur from use of filaments or electrodes. The very clean and deposit-free fiber surface ensures reliable operation of very high power fiber lasers or power delivery systems.

FIG. 3 shows a conventional fiber processing systems using a CO₂ laser to shine a single laser beam on one side A1 of the exterior surface of a fiber thereby irradiating and heating primarily that side A1 of the fiber. The exterior surface of the fiber on which the beam is not directly incident (i.e. the surface A2 which is opposite to A1) is heated indirectly by heat transfer from the surface A1 on which the laser is incident. Consequently, the exterior surface of the fiber is non-uniformly heated and may have a non-uniform temperature distribution. With reference to FIG. 3, the temperature on the A1 side of the fiber is higher than the temperature on the A2 side of the fiber.

The non-uniform heating of the fiber surface and the non-uniform temperature may cause the fiber to change shape as shown in FIG. 4. Especially for hollow and capillary fibers (and other fibers having a cylindrical hole in the center) the shape of the fibers and of the cylindrical hole in the center may change to asymmetrical shapes. FIGS. 4A and 4B show the change in fiber shape for a hollow fiber. FIGS. 4C and 4D show the change in fiber shape for a full fiber. This change in shape of the fiber, due to heat processing such as splicing and tapering, is detrimental to the optical properties of the fiber and is unwanted.

It is an object of the invention to provide an optical fiber splicing, tapering and heat processing apparatus that performs a significantly more uniform heating of the fibers than conventional systems, thereby reducing the shape changes of the optical fibers during splicing, tapering and heat processing.

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

The foregoing general description and the following detailed description are only exemplary and explanatory and they are intended to provide further explanation of the invention as claimed.

### SUMMARY

Additional features of the invention will be set forth in the description which follows, and in part will be apparent from the description, or may be learned by practice of the invention.

One embodiment of the invention discloses an apparatus for splicing, tapering and heat processing optical fibers. The apparatus may include a laser configured to irradiate a portion of one or more optical fibers by at least two laser beams. The beams may be configured to irradiate different areas of the exterior surface of the fiber portion.

In another embodiment the laser may be configured to irradiate the exterior surface of the fiber portion by a first beam and a second beam. The first beam may irradiate a first area of the fiber portion and the second beam may irradiate a second area of the fiber portion opposite to the first area. The power of the first beam may be substantially equal to the power of the second beam.

The angle between the first beam and the second beam may be the closest angle to 180 degrees for which coupling between the first beam and the second beam is avoided in order to avoid coupling energy from either beam back to the laser energy source.

In another exemplary embodiment the apparatus for splicing, tapering and heat treating optical fibers may include: a primary beam emitted by the laser beam; a beam splitter splitting the primary beam in a first beam and a second beam having substantially the same power as the first beam; a first mirror deflecting the first beam on a first area of the fiber portion; and a second mirror deflecting the second beam on a second area of the fiber portion opposite to the first area.

In another exemplary embodiment the apparatus for splicing, tapering and heat treating optical fibers may include three or more beams. The beams may be incident on the exterior surface of the fiber portion; the powers of the beams are substantially equal to each other; the beams' directions are forming substantially the same angle with the fiber; and beams are disposed around the fiber such that they are spaced by angles that are substantially equal to each other. The beam powers, beam profiles on the fiber and configurations of the beams may be such that the irradiation uniformity on the exterior surface of the fiber portion is maximized.

In another exemplary embodiment a method for processing optical fibers is disclosed. The method may include irradiating a portion of one or more optical fibers by at least two laser beams, wherein the beams are configured to irradiate different areas of the exterior surface of the fiber portion.

In another exemplary embodiment a method for processing optical fibers wherein the method may include irradiating the fiber by three or more beams. The beams may be incident on the exterior surface of the fiber portion; the powers of the beams may be substantially equal to each other; the beams' directions may form substantially the same angle with the fiber; and the beams may be disposed around the fiber such that they are spaced by angles that are substantially equal to each other. The beams may be disposed in such a way that coupling between the beams is avoided.

It is to be understood that both the foregoing general description and the following detailed description are exemplary and explanatory and are intended to provide further explanation of the invention as claimed.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 shows a schematic diagram of splicing two optical fibers according to an exemplary embodiment of the present invention.

FIG. 2 shows a schematic diagram of tapering an optical fiber according to an exemplary embodiment of the present invention.

FIG. 3 shows a fiber and beam part of a conventional fiber processing systems using a CO₂ laser to shine a single laser beam on one side of the exterior surface of a fiber.

FIG. 4 shows the effects of processing a hollow fiber and a full fiber by a conventional fiber processing system employing a single laser beam.

FIG. 5 shows an apparatus for splicing, tapering and heat processing optical fibers according to an exemplary embodiment of the present invention.

FIG. 6 shows a beam and fiber configuration of an apparatus for splicing, tapering and heat processing optical fibers according to an exemplary embodiment of the present invention.

FIG. 7 shows a beams and fiber configuration of an apparatus for splicing, tapering and heat processing optical fibers according to another exemplary embodiment of the present invention.

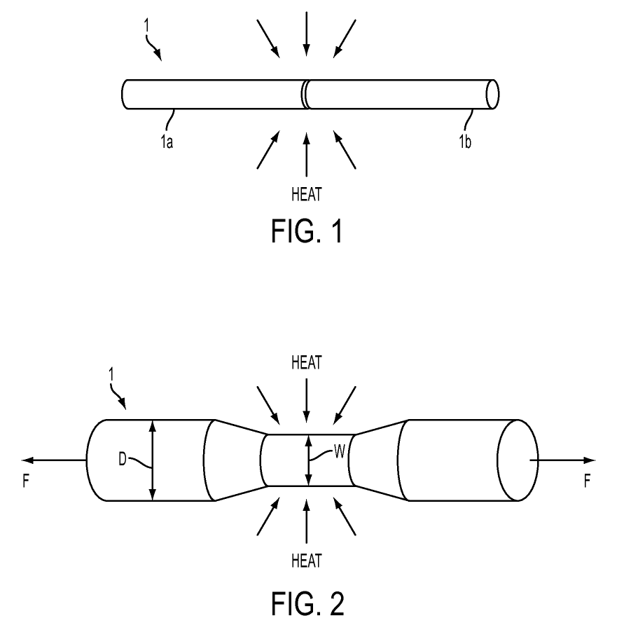

### DETAILED DESCRIPTION

The following detailed description is provided to gain a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Throughout the drawings and the detailed description, unless otherwise described, the same drawing reference numerals are understood to refer to the same elements, features, and structures. The relative size and depiction of these elements may be exaggerated for clarity.

Further, it will be understood that when an element is referred to as being “connected to” another element, it can be directly connected to the other element, or intervening elements may be present. The terminology used herein is for the purpose of describing particular embodiments only and is not intended to be limiting of the present disclosure.

Although some features may be described with respect to individual exemplary embodiments, aspects need not be limited thereto such that features from one or more exemplary embodiments may be combinable with other features from one or more exemplary embodiments.

Hereinafter, an exemplary embodiment will be described with reference to accompanying drawings.

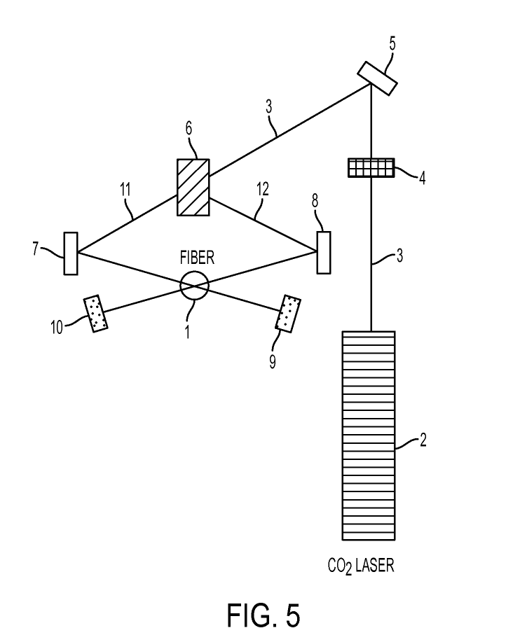

FIG. 5 shows a schematic diagram of an apparatus for splicing, tapering and heat processing of one or more optical fibers according to an exemplary embodiment of the invention. The apparatus may include: a fiber 1; a CO₂ laser 2 emitting a laser beam 3; a safety shutter 4; a folding mirror 5; a beam splitter 6; a first deflection mirror 7; a second deflection mirror 8; a first laser beam dump or thermopile 9 and a second laser beam dump or thermopile 10.

The CO₂ laser 2 may emit a laser beam 3 which may be reflected by a folding mirror 5 onto a beam splitter 6. The beam splitter 6 may be a 50% beam splitter thereby splitting the beam 3 into a first beam 11 and a second beam 12. The beams 11 and 12 may have substantially the same powers and the same shapes. A first deflection mirror 7 may be used to deflect the first beam 11 onto a portion of the fiber 1 and a second deflection mirror 8 may be used to deflect the second beam 12 onto the portion of fiber 1. The laser beams 11 and 12 may irradiate only the portion of the fibers 1 which undergoes tapering, splicing or heat processing. For instance, in the case of splicing two fibers, the laser beams may irradiate only a length of the fibers around the ends of the fibers to be spliced.

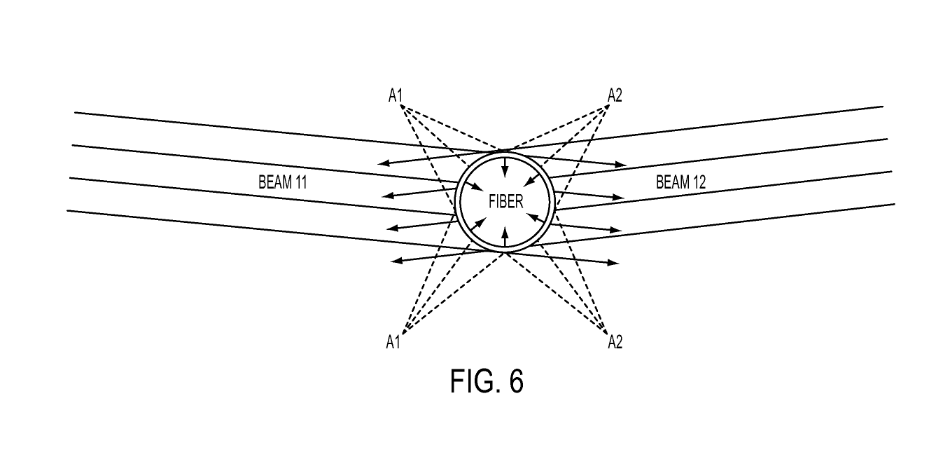

FIG. 6 shows a close-up view of a configuration of the fiber 1 and laser beams 11 and 12 according to an exemplary embodiment of the invention. The first beam 11 may be incident on a first area A1 whereas the second beam 12 may be incident on another area A2. The areas A1 and A2 may be disposed on opposite sides of the fiber portion. The areas A1 and A2 may cover the entire exterior surface of the fiber portion or a large percentage of the entire exterior surface of the fiber portion. Parts of the laser beams 11 and 12 may be absorbed by the fiber material under the areas A1 and A2 respectively, thereby heating the fiber region under areas A1 and A2. The heated fiber regions under areas A1 and A2 may conduct the heat/energy into the fiber inner structure.

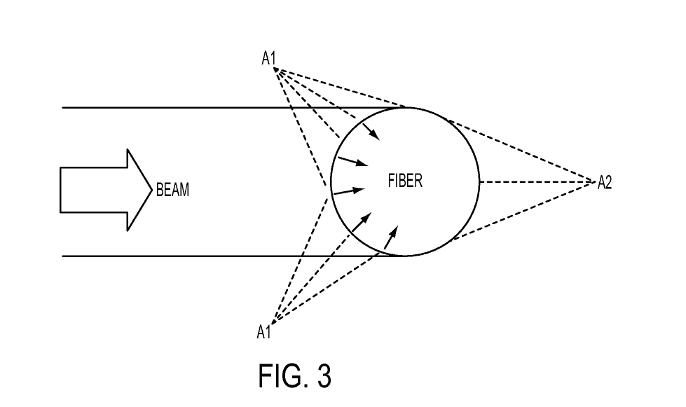

Since the beams 11 and 12 have substantially the same shape the areas A1 and A2 have substantially the same size. Further, since the beams 11 and 12 have substantially the same powers the energy transmitted to the first area A1 is substantially equal to the energy transmitted to the second area A2. This way the exterior surface of the fiber portion is significantly more uniformly heated than in a situation such as the one shown in FIG. 3 where the fiber portion is irradiated by a single beam falling only on one side A1 of the fiber. Consequently, the temperature distribution over the fiber portion may be significantly more uniform when an apparatus configuration using two beams to irradiate the fiber, as shown in FIGS. 5 and 6, is employed than the temperature distribution over the fiber portion when an apparatus configuration using one beam, as the configuration shown in FIG. 3, is employed. On the other hand, the cost of the apparatus may increase.

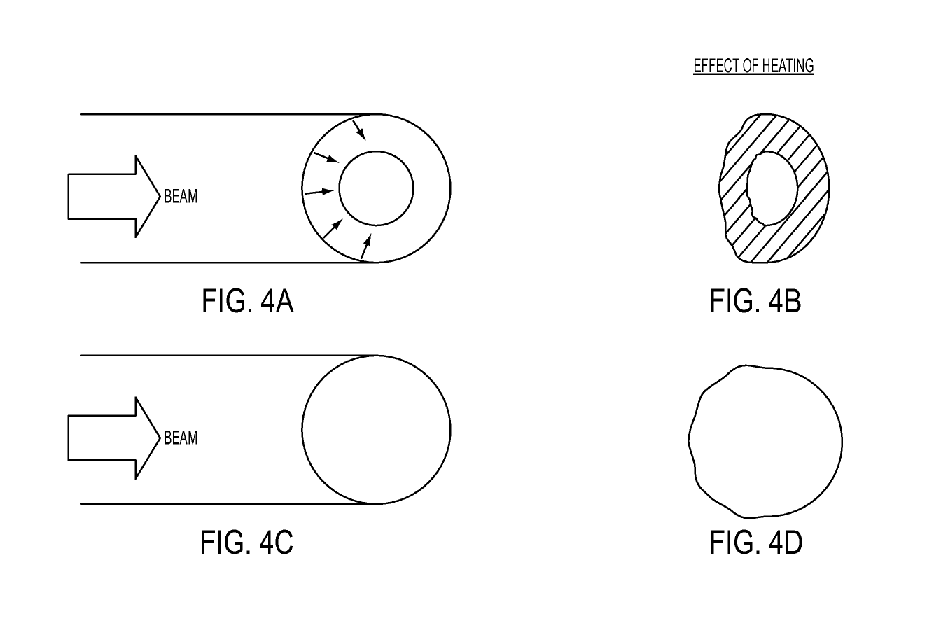

The significantly more uniform heating of the fiber portion achieved by an apparatus using two beams incident on the fiber, as the one described above and shown in FIGS. 5 and 6, leads to a splicing or tapering process in which the shape of the processed fiber does not suffer the distortions shown in FIG. 4B. Therefore, by using an apparatus according to the exemplary embodiments shown in FIGS. 5 and 6 it is possible to perform splicing and tapering of better quality. Especially in the case of hollow fibers or capillary fibers the splicing and tapering performed by an apparatus using two beams leads to significantly improved quality of the processed fibers.

The beams 11 and 12 may be guided on to the fiber portion from directions exactly opposite to each other (e.g. the angle between the beams is 180 degrees). However, if the beams 11 and 12 are guided from directions exactly opposed to each other the two beams may couple with each other. Coupling between the beams may be detrimental to the functioning of the apparatus because the energy of one or more of the beams may cause power instability and reflect back to the laser source causing disruption or damage. The beams 11 and 12 may be disposed at an angle with respect to each other, as shown in FIGS. 5 and 6, such as to avoid coupling between the two beams and, at the same time, to obtain good heating uniformity of the fiber portion. The positions of the mirrors and the fibers may be adjusted such that a desired heating uniformity is achieved and, at the same time, a desired degree of decoupling between the beams is achieved such that no beam energy is directed back into the laser energy source. The positions of the mirrors and fibers may be adjusted such that the angle between beams 11 and 12 is the closest angle to 180 degrees for which coupling between the beams does not occur. Here, the closest angle refers to the closest angle to 180 degrees that may be obtained by reasonable expense and effort considering the purpose of the apparatus and the technical and economic circumstances.

The part of laser beams 11 and 12 which is not absorbed by the fibers may be absorbed by laser beam dumps or thermopiles 9 and 10 for safety and power measurements. A safety shutter may be disposed at the output of the CO₂ laser

The CO₂ laser power may be from about 0.5 W to about 100 W. The laser spot size at the level of the fibers may be from about 0.5 mm to 10 mm. However, aspects of the invention are not limited by the type of laser used, by the laser power or by the spot size. For example, other types of laser, different from CO₂ laser and other combinations of laser powers and spot sizes may be used.

The fibers may have a diameter between 20 micron and 3000 micron. The fibers may be made out of various materials, such as Silica based glass, Fluoride glass, Chalcogenide glass, Zblan glass, etc. However, aspects of the invention are not limited by the fibers' size and materials. The apparatus may be used to process fibers of other types, sizes and materials.

The specific embodiments described in this application disclose an apparatus which may be used to perform both splicing and tapering of fibers. In the case the apparatus is used for splicing, the two fibers to be spliced are placed end to end in the apparatus as shown in FIG. 5. The distance between the two fibers may be adjusted by a fiber positioning unit such as to ensure an end to end fiber distance proper for splicing the two fibers. The CO₂ laser 2 may shine a laser beam 3 on a target area of the two fibers. The target area may cover both an end of the first fiber and an end of the second fiber. The laser beam may heat the ends of the fibers to such temperatures and for such a length of time as to weld the two fiber ends together. The laser beam may cause partial melting and other physical and chemical changes of the fiber material. By controlling the temperature distribution of the fibers and the length of time the fibers are heated, the two fibers may be spliced into a single fiber having good properties, such as low splice loss and good splice strength.

In the case the apparatus is used for tapering, the fiber to be tapered 1 is placed in the apparatus as shown in FIG. 5. Forces may be applied to the fiber and the position of the fiber may be adjusted. The two laser beams 11 and 12 may guided on to a portion of the fiber. The fiber may be properly tapered by controlling the temperature distribution over the fiber and the length of time the fiber is heated.

The output of the laser beam may be adjusted such as to obtain a desired splicing and/or tapering. The laser power may be increased such as to deliver more energy to the fibers. Conversely, the laser power may be decreased such as to deliver less energy to the fibers. The laser wavelength is such that the fiber material absorbs part of the incident laser light. Part of the absorbed laser light is transformed into heat. Preferably, the laser wavelength and fiber material are such that a high percentage of the laser light incident on the fibers is absorbed and a high percentage of the absorbed light is transformed into heat. If needed, the laser output may be further adjusted such as to change the focus of the laser beam or to change the direction of the laser beam.

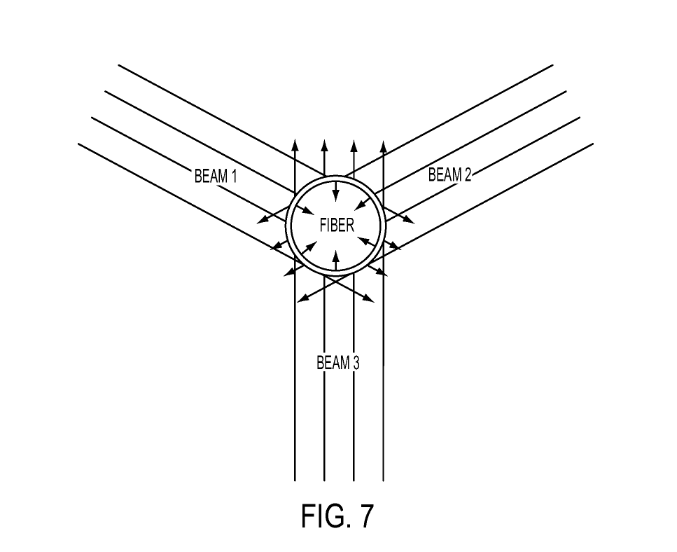

In an exemplary embodiment of the invention it is disclosed an apparatus where three beams are simultaneously guided on to the fiber portion as shown in FIG. 7. The three beams may have the same power. The three beams may have the same size and beam profile on the surface of the fiber. The three beams may be disposed such that the angles between them are equal to each other. The three beams may be perpendicular on the fiber.

A three beam configuration, as the one shown in FIG. 7, may be implemented by using two beam splitters. The first beam splitter may split the primary beam of the CO₂ laser into a first beam having 33% of the primary beam's power and a second beam having 66% of the primary beam's power. Then the second beam may be split into two beams by a 50/50 beam splitter. Thereby the three beams may be directed on the fiber by mirrors according to the configuration shown in FIG. 7. An apparatus configuration using three beams to irradiate and heat the fiber, as shown in FIG. 7, may create a more uniform heating distribution over the fiber portion than an apparatus configuration using two beams as the configuration shown in FIG. 5. On the other hand, the cost of the apparatus may increase.

Any number and combinations of beams may be used to irradiate the fiber. For instance, exemplary embodiments are disclosed that employ 4 and 5 beams, respectively, incident on the fibers. The beams may have the same powers. The beams may have different powers. The beams may be disposed at different angles to each other and may have different sizes and profiles. Various combinations and configurations of beams, powers, angles, and beam shapes may be employed. Combinations and configurations may be chosen such as to increase heating uniformity over the fibers, avoid coupling between beams, reduce cost, minimize size, and others.

The powers of the beams, the angles between the beams, the angles the beams form with the fibers, and the beam profiles may be set and/or adjusted such as to maximize the irradiation uniformity on the exterior surface of the fiber portion. Here, the term maximize refers to a maximizing degree/process that may be obtained by reasonable expense and effort considering the purpose of the apparatus and the technical and economic circumstances.

The apparatus may further comprise a beam positioning and alignment unit performing alignment or changing the beam position. The beam alignment and position changing may be performed by an operator or automatically. The apparatus may further comprise a beam shape and size adjusting unit for changing the shape and size of the beam. The changing of beam shape and size may be performed by an operator or automatically. The beam shape may be changed and adjusted such as to obtain a circular beam, an oval beam, a linear beam or other shapes. The apparatus may further include a power meter such as a thermopile for measuring the beam powers. The apparatus may further include a beam imaging system such that an operator may view on a display a beam size and position.

In another exemplary embodiment the apparatus may further include a feedback system for controlling and stabilizing the irradiation of the fibers. The feedback system may include one or more beam sampler detectors for sampling the beams incident on the fiber and/or the primary beam emitted by the CO₂ laser. The feedback system may further include one or more cameras disposed around the fiber such as to collect images of the fiber. The images may be indicative of the brightness distribution over the fiber. Further, an image analysis unit may analyze the images. A controller may use the images, the results of the image analysis, and signals received from the detector as feedback parameters. Based on the feedback parameters, the controller may control the output of the laser such as to stabilize a brightness distribution over the fiber, a temperature distribution, a laser output or other quantities. The camera exposure times may be adjusted by using an interface. A warm tapering image brightness level may be captured in real time during tapering process. A warm tapering image value may be used to adjust the CO₂ laser in real time.

The controller may control the output of the laser such as to change a brightness distribution over the fiber, based on the feedback parameters received, in a predetermined manner. Taper measurements may show both a fiber diameter and a fiber center profile. The controller may also control positions of the fibers, forces applied on the fibers, mirror positions and other parameters of the apparatus.

The various components of the apparatus may be interfaced and controlled by a computer system.

In another exemplary embodiment the apparatus for splicing and tapering fibers may have a modularized structure. For example, the apparatus may include: a splicer module; an optical module; a laser module; a PC and accessories module; and movable station with frames module. The apparatus may be configured such that individual modules are easily removable. For example, the apparatus may be configured such that the splicer module is easily removable for service and repair. Further, the apparatus may be configured such that the laser module is easily removable for gas recharge.

The invention is not limited by the presence or absence of the folding mirror 5, the deflection mirrors 7 and 8, the safety shutter 4 or the laser beam dumps or thermopiles 9 and 10. For instance, an apparatus may be implemented without the folding mirror 5 where the beam is directly incident on the beam splitter. Further, an apparatus that does not employ a safety shutter or laser beam dumps or thermopiles may be implemented. Further, an apparatus may employ another means to deflect or redirect the laser beam such as a flexible waveguide as an alternative to deflection mirrors or folding mirrors.

In conclusion, the invention in this applications discloses a system and apparatus for splicing, tapering and heat processing optical fibers which is significantly improved with respect to the conventional splicing and tapering systems. Systems employing two or three beams incident on the fiber, as the ones disclose above and shown in FIGS. 5-7, perform significantly better fiber splicing, tapering and heat processing than conventional system employing a single beam. This is in part due to the fact that the system disclosed in this application achieves a significantly more uniform heating of the fibers than conventional systems. Especially in the case of hollow fibers or capillary fibers the splicing and tapering performed by an apparatus using two or more beams leads to significantly improved quality of the processed fibers.

A CO₂ laser based fiber processing system as described in the above exemplary embodiments may easily splice fibers with extremely large diameter differences. For example, splicing a 2 mm diameter end-cap glass rod to a 0.125 mm diameter fiber is a tremendous challenge for all conventional heating sources. In order to soften the 2 mm rod, very high power must be applied. But high power may completely melt the 0.125 mm fiber, vaporizing the fiber or creating a ball end. On the contrary, this type of splice is a relatively straightforward process when using the CO₂ heating source. The fiber heating mechanism of a CO₂ laser is fundamentally different from all other heating methods such as flame, arc discharge, and filament. The silica based optical fiber is heated by its absorption of the 10.6 micron wavelength CO₂ laser energy, while all other heating methods use radiation and heat conduction. A large diameter fiber has a larger absorption surface, while a small diameter fiber has a smaller absorption surface. Thus, the power of the CO₂ laser does not need to be substantially different when splicing two fibers with different diameters.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed:

1. An apparatus for processing optical fibers, the apparatus comprising:
a laser configured to irradiate a portion of one or more optical fibers by at least two laser beams, wherein the beams are configured to irradiate different areas of the exterior surface of the fiber portion.

2. The apparatus of claim 1, wherein the laser is configured to irradiate the exterior surface of the fiber portion by a first beam and a second beam, wherein:
the first beam irradiates a first area of the fiber portion;
the second beam irradiates a second area of the fiber portion substantially opposite to the first area; and
the power of the first beam is substantially equal to the power of the second beam.

3. The apparatus of claim 2, wherein the angle between the first beam and the second beam is the closest angle to 180 degrees for which coupling between the first beam and the second beam is avoided.

4. The apparatus of claim 1, further comprising:
a primary beam emitted by the laser beam;
a beam splitter splitting the primary beam in a first beam and a second beam having substantially the same power as the first beam;
a first mirror or other means of deflecting or guiding the first beam on a first area of the fiber portion; and
a second mirror or other means of deflecting or guiding the second beam on a second area of the fiber portion opposite to the first area.

5. The apparatus of claim 4, wherein the angle between the first beam and the second beam is the closest angle to 180 degrees for which coupling between the first beam and the second beam is avoided.

6. The apparatus of claim 1, wherein the laser is configured to irradiate the exterior surface of the fiber portion by three or more beams, wherein:
the beams are incident on the exterior surface of the fiber portion;
the powers of the beams are substantially equal to each other;
the beams' directions are forming substantially the same angle with the fiber; and
beams are disposed around the fiber such that they are spaced by angles that are substantially equal to each other.

7. The apparatus of claim 1, wherein the beam powers, beam profiles on the fiber and configurations of the beams are such that the irradiation uniformity on the exterior surface of the fiber portion is maximized.

8. The apparatus of claim 1, further comprising:
one or more cameras disposed around the fibers and configured to collect images of different areas of a region of the fiber; and
an image display and processing unit configured to receive images from the cameras in real time, to combine the collected images into a combined image, and to send the combined image to a display.

9. The apparatus of claim 1, further comprising a feedback system for controlling and stabilizing the irradiation on the fibers, wherein the feedback system comprises:
one or more cameras configured to receive light from one or more areas of the fibers and form images of the one or more areas; and
a controller configured to receive images from the cameras;
wherein the controller is configured to use the images received from the cameras as feedback parameters and to control the laser output according to said signal and said images such as to stabilize a brightness of the fibers.

10. The apparatus of claim 9, wherein the feedback system further comprises:
one or more beam samplers and detectors configured to sample the power of the beams;
wherein the controller is further configured to receive signals from the detectors;
wherein the controller is configured to use the signals received from the detectors as feedback parameters and to control the laser output according to said signals and said images such as to stabilize a brightness of the fibers.

11. The apparatus of claim 1, wherein the size and shape of the laser beam spot irradiating the fibers is adjustable.

12. A method for processing optical fibers, the method comprising:
irradiating a portion of one or more optical fibers by at least two laser beams, wherein the beams are configured to irradiate different areas of the exterior surface of the fiber portion.

13. The method of claim 12, wherein the at least two laser beams comprise:
a first beam irradiating a first area of the fiber portion;
a second beam irradiating a second area of the fiber portion opposite to the first area, the power of the second beam being substantially equal to the power of the first beam.

14. The method of claim 13, further comprising:
setting an angle between the first beam and the second beam such that the angle is the closest angle to 180 degrees for which coupling between the first beam and the second beam is avoided.

15. The method of claim 12, wherein the at least two laser beams comprise three or more beams, wherein:
the beams are incident on the exterior surface of the fiber portion;
the powers of the beams are substantially equal to each other;
the beams' directions are forming substantially the same angle with the fiber; and
beams are disposed around the fiber such that they are spaced by angles that are substantially equal to each other.

16. The method of claim 15, wherein the beams are disposed in such a way that coupling between the beams is avoided.

17. The method of claim 12, further comprising:
setting or adjusting the powers of the beams; the angles between the beams; the angles the beams form with the fibers; and the profiles of the beams such as to maximize the irradiation uniformity on the exterior surface of the fiber portion.

18. The method of claim 12, further comprising:
setting or adjusting the powers of the beams, the angles between the beams, the angles the beams form with the fibers, and the profiles of the beams such as to maximize the irradiation uniformity on the exterior surface of the fiber portion and such that coupling between the beams is avoided.
